(19) United States
(12) Patent Application Publication
(10) Pub. No.: US 2018/0199539 A1
(43) Pub. Date: Jul. 19, 2018

(54) Round Bale Saddle Feeder

(71) Applicant: Dennis Robison, San Angelo, TX (US)

(72) Inventor: Dennis Robison, San Angelo, TX (US)

(21) Appl. No.: 15/408,108

(22) Filed: Jan. 17, 2017

(51) Int. Cl. A01K 5/01

(52) U.S. Cl. CPC A01K 5/01

(57) ABSTRACT

Disclosed herein is an apparatus for feeding livestock, which suspends one or more round hay bales above the ground, preventing hay rot, at a height that enables large livestock to feed on the round hay bales while small or young livestock feed from the underside of the bale where they are better protected from the larger animals. The round hay bale feeder comprises a box frame; one or more baskets for supporting a round hay bale disposed within the box frame; a base comprising pipe skids, and a plurality of vertical supports that support the basket or baskets, which allow enough space for small or young animals to feed underneath the feeder; and one or more hinged and latched gates for accessing the feeder.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

### 1. Field of the Invention

The present invention is in the technical field of animal feeders. More particularly, the preferred embodiments of the present invention relate generally to feeders for livestock. More particularly, the preferred embodiments of the present invention relate generally to hay feeders for livestock. More particularly, the preferred embodiments of the present invention relate generally to round bale hay feeders for livestock. More particularly, the preferred embodiments of the present invention relate generally to round bale hay feeders for livestock, which allow small livestock, or young animals, to safely feed simultaneously alongside large animals.

### 2. Description of the Related Art

The broad concept of animal feeders is known. These inventions include feeders for wild animals, such as birds or deer, and feeders for domesticated animals.

It is also known to use feeders for livestock. However, these inventions are often susceptible to wasting or damaging the feed, which may cause the livestock to be prone to illness or disease.

It is also known to use hay feeders for livestock. However, these inventions often place the hay at or near the ground, where the hay is disposed to rot often resulting in illness or disease to feeding livestock. Additionally, common hay feeders allow livestock to spread the hay around, which exposed the hay to urination by the livestock, which substantially wastes the hay and increases the expense of feeding the livestock.

It is also known to use round bale hay feeders. However, these inventions often position the round hay bale on or near the ground, where it is vulnerable to rot or pest infestation that can spread through the round hay bale and ruin the entire bale. Furthermore, common round bale hay feeders do not provide access for young livestock, which benefit greatly from the early adoption of feeding on hay, and young livestock that attempt to feed next to mature livestock are at risk of being trampled or otherwise injured by the larger animals.

Round bale hay feeders, which use pipe skids, are also known. However, these inventions usually have structural cross bars for reinforcing the skids, which limit access to the round hay bale and prevent young livestock from being able to feed from the underside of the round hay bale and may result in wasted feed.

It is also known to use round bale hay feeders, which have centered vertical supports. However, these inventions usually have other support structures, such as cross bars, which limit access to the round hay bale and prevent young livestock from being able to feed from the underside of the round hay bale and may result in wasted feed.

It is also known to use hay feeders that use multiple bales. However, these inventions do not provide protected spaces for young livestock to feed simultaneously next to larger, mature livestock.

### SUMMARY OF THE INVENTION

Farmers and ranchers who raise livestock often use round hay bales of standard sizes to feed their animals; however, difficulties may arise when using these round hay bales. Positioning a round hay bale directly on the ground makes the hay more susceptible to rot or to being damaged by feeding animals, which wastes hay and makes it more expensive to feed livestock. Supporting a round hay bale above the ground may prevent rot, but often the supporting mechanism impedes livestock from completely accessing the hay, which can also waste hay. The Round Bale Saddle Feeder invention was developed in part to overcome the problems involved in using round hay bales.

The broad embodiments of the present invention relate generally to an apparatus for feeding livestock, which suspends a round hay bale above the ground, preventing hay rot, at a height that enables animals to feed on the round hay bale from top to bottom and allows small or young animals to feed from the underside of the bale where they are better protected from the larger animals. In more detail, the Round Bale Saddle Feeder has multiple embodiments, including a single round hay bale feeder, a double round hay bale feeder and a triple round hay bale feeder.

In the most preferred embodiments, the present invention relates to an apparatus for feeding a single round hay bale to livestock, which provides a protected space under the round hay bale that allows small animals and/or young livestock to safely feed from the underside of the round hay bale while more mature, larger animals simultaneously feed from the sides or top of the round hay bale. The single round hay bale feeder comprises a box frame; a saddle-shaped basket for supporting a round hay bale comprising a large weave pattern of flat steel bars with openings large enough for animals to feed through without becoming caught while feeding, which is disposed within the box frame; a base comprising pipe skids, and a plurality of vertical supports that extend from the center cross support to the lowest point of the underside of the saddle-shaped basket, which allow enough space for small or young animals to feed underneath the feeder and set the saddle-shaped basket at a height that allows animals to feed from top to bottom until the hay feeder is empty; and a hinged gate and latch on the end of the saddle-shaped basket that make the feeder easier to access.

In another preferred embodiment, the present invention relates to an apparatus for feeding two round hay bales to livestock, which provides a protected space under the round hay bales that allows small animals and/or young livestock to safely feed from the underside of the round hay bale while more mature, larger animals simultaneously feed from the sides or top of the round hay bale. The double round hay bale feeder comprises a box frame; two saddle-shaped baskets joined with a support panel, each saddle-shaped basket being capable of supporting a round hay bale and comprising a large weave pattern of flat steel bars with openings large enough for animals to feed through without becoming caught while feeding, which are disposed within the box frame; a base comprising pipe skids with a plurality of cross supports, and a plurality of vertical supports that extend from the cross supports to the lowest points of the underside of each of the saddle-shaped baskets, which allow enough space for small or young animals to feed underneath the feeder and set the saddle-shaped basket at a height that allows animals to feed from top to bottom until the hay feeder is empty; and hinged swing gates and latches on the outside of each saddle-shaped basket that make the feeder easier to access.

In another preferred embodiment, the present invention relates to an apparatus for feeding three round hay bales to livestock, which provides a protected space under the round hay bales that allows small animals and/or young livestock to safely feed from the underside of the round hay bale while more mature, larger animals simultaneously feed from the sides or top of the round hay bale. The triple round hay bale feeder comprises a box frame; a large saddle-shaped basket, which is capable of supporting three round hay bales and which comprises a large weave pattern of flat steel bars with openings large enough for animals to feed through without becoming caught while feeding, which are disposed within the box frame; a base comprising pipe skids with a plurality of cross supports, and a plurality of vertical supports that extend from the cross supports to the lowest points of the underside of each of the saddle-shaped baskets, which allow enough space for small or young animals to feed underneath the feeder and set the saddle-shaped basket at a height that allows animals to feed from top to bottom until the hay feeder is empty; and hinged swing gates and latches on the outside of the saddle-shaped basket which make the feeder easier to access.

### BRIEF DESCRIPTION OF THE DRAWING

Illustrative and preferred embodiments of the present invention are shown in the accompanying drawings in which:

FIG. 1 is a perspective view of the most preferred embodiment of the present invention;

FIG. 2 is a front view of an apparatus of FIG. 1;

FIG. 3 is a rear view of an apparatus of FIG. 1;

FIG. 4 is a side view of an apparatus of FIG. 1;

FIG. 5 is a top view of an apparatus of FIG. 1;

FIG. 6 is a perspective view of an apparatus of FIG. 1 loaded with a round hay bale and showing livestock feeding from the apparatus;

FIG. 7 is a front view of an apparatus of FIG. 1 loaded with a round hay bale and showing livestock feeding from the apparatus;

FIG. 8 is a side view of an apparatus of FIG. 1 loaded with a round hay bale and showing livestock feeding from the apparatus;

FIG. 9 is a perspective view of another preferred embodiment of the present invention;

FIG. 10 is a front view of an apparatus of FIG. 9;

FIG. 11 is a rear view of an apparatus of FIG. 9;

FIG. 12 is a side view of an apparatus of FIG. 9;

FIG. 13 is a top view of an apparatus of FIG. 9;

FIG. 14 is a perspective view of an apparatus of FIG. 9 loaded with two round hay bales and showing livestock feeding from the apparatus;

FIG. 15 is a front view of an apparatus of FIG. 9 loaded with two round hay bales and showing livestock feeding from the apparatus;

FIG. 16 is a side view of an apparatus of FIG. 9 loaded with two round hay bales and showing livestock feeding from the apparatus;

FIG. 17 is a perspective view of another preferred embodiment of the present invention;

FIG. 18 is a front view of an apparatus of FIG. 17;

FIG. 19 is a rear view of an apparatus of FIG. 17;

FIG. 20 is a side view of an apparatus of FIG. 17;

FIG. 21 is a top view of an apparatus of FIG. 17;

FIG. 22 is a perspective view of an apparatus of FIG. 17 loaded with three round hay bales and showing livestock feeding from the apparatus;

FIG. 23 is a front view of an apparatus of FIG. 17 loaded with three round hay bales and showing livestock feeding from the apparatus;

FIG. 24 is a side view of an apparatus of FIG. 17 loaded with three round hay bales and showing livestock feeding from the apparatus; and

FIG. 25 is a perspective view of an apparatus of FIG. 17 showing both the front gate and the rear gate in an open position.

### DETAILED DESCRIPTION OF THE PREFERRED EMBODIMENTS

For the purpose of illustration, the present invention is shown in the most preferred embodiments of an apparatus for feeding a single round hay bale to livestock, which provides a protected space under the round hay bale that allows small animals and/or young livestock to safely feed from the underside of the round hay bale while more mature, larger animals simultaneously feed from the sides or top of the round hay bale; an apparatus for feeding two round hay bales to livestock, which provides a protected space under the round hay bales that allows small animals and/or young livestock to safely feed from the underside of the round hay bales while more mature, larger animals simultaneously feed from the sides or top of the round hay bale; and an apparatus for feeding three round hay bale to livestock, which provides a protected space under the round hay bale that allows small animals and/or young livestock to safely feed from the underside of the round hay bale while more mature, larger animals simultaneously feed from the sides or top of the round hay bale. These embodiments of the round hay bale feeders comprise a box frame; a saddle-shaped basket or baskets for supporting one or more round hay bales, which comprises a large weave pattern of flat steel bars with openings large enough for animals to feed through without becoming caught while feeding, which are disposed within the box frame; a base comprising pipe skids, and a plurality of vertical supports that extend from the center cross support to the lowest point of the underside of the saddle-shaped basket or baskets, which allow enough space for small or young animals to feed underneath the feeder and set the saddle-shaped basket or baskets at a height that allows animals to feed from top to bottom until the hay feeder is empty; and one or more hinged gates with latches that make the feeder easier to access. These embodiments may further comprise steel hook attachments on either end of the box frame that receive chains to move the feeders from one location to another. Further, each embodiment of the Round Bale Saddle Feeder invention is set at a height, which allows round hay bales to be easily unloaded from a pickup truck onto the feeders, enabling small farmers or ranchers, who lack heavy farm equipment, to easily use round hay bales. In sum, the Round Bale Saddle Feeder invention provides a convenient and cost effective means of feeding livestock with round hay bales. These embodiments are not intended to limit the scope of the present invention.

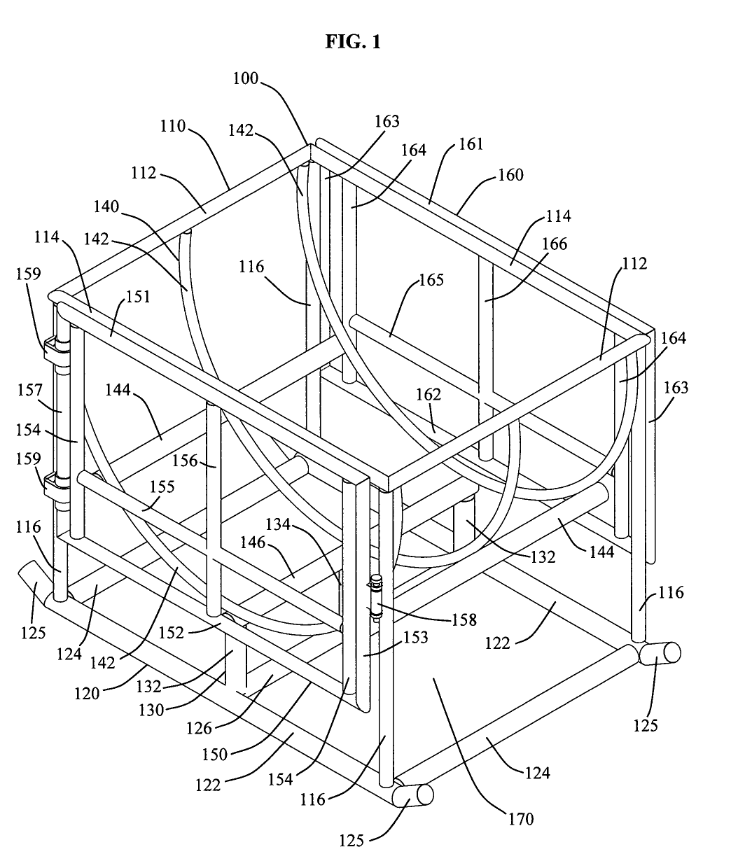

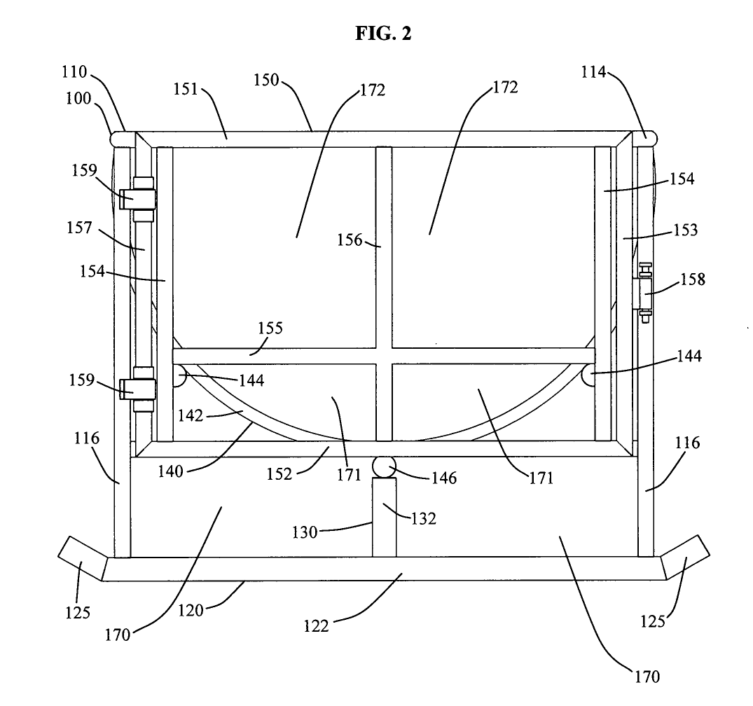

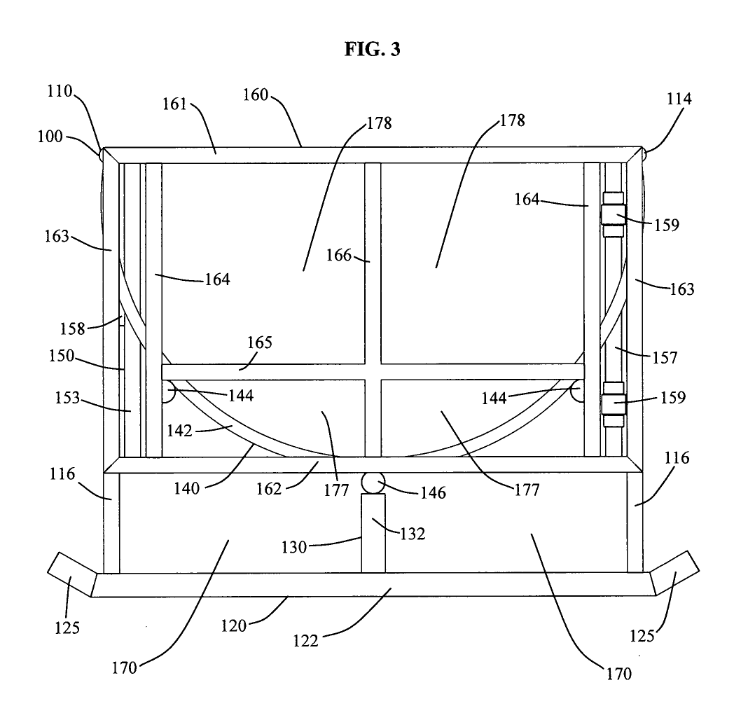

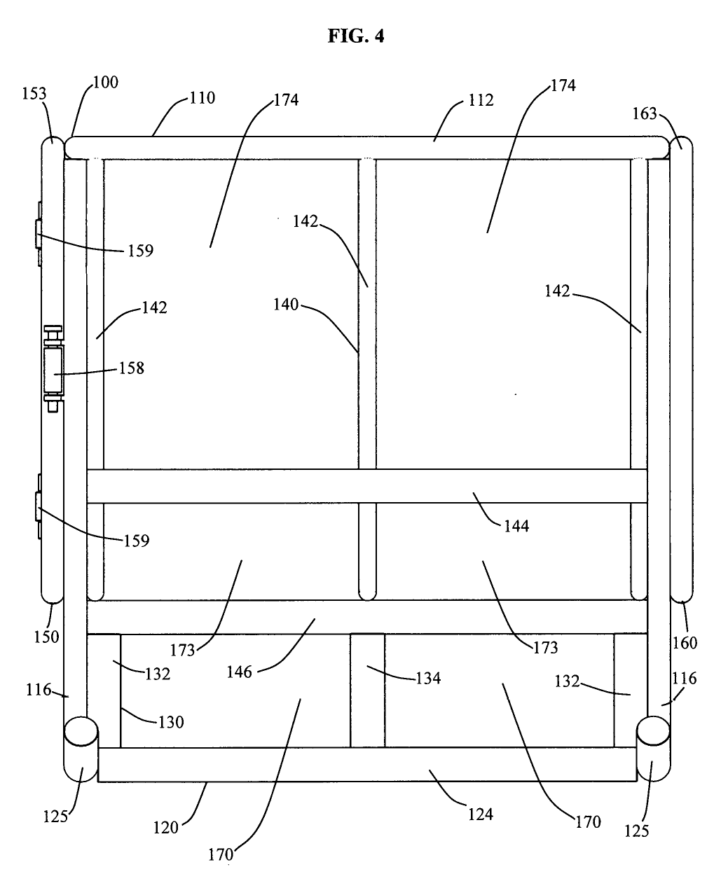

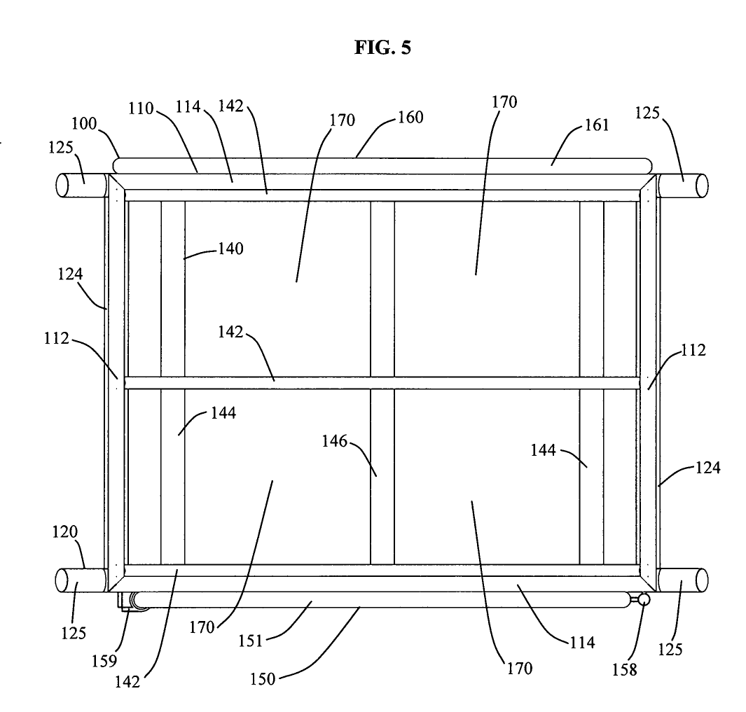

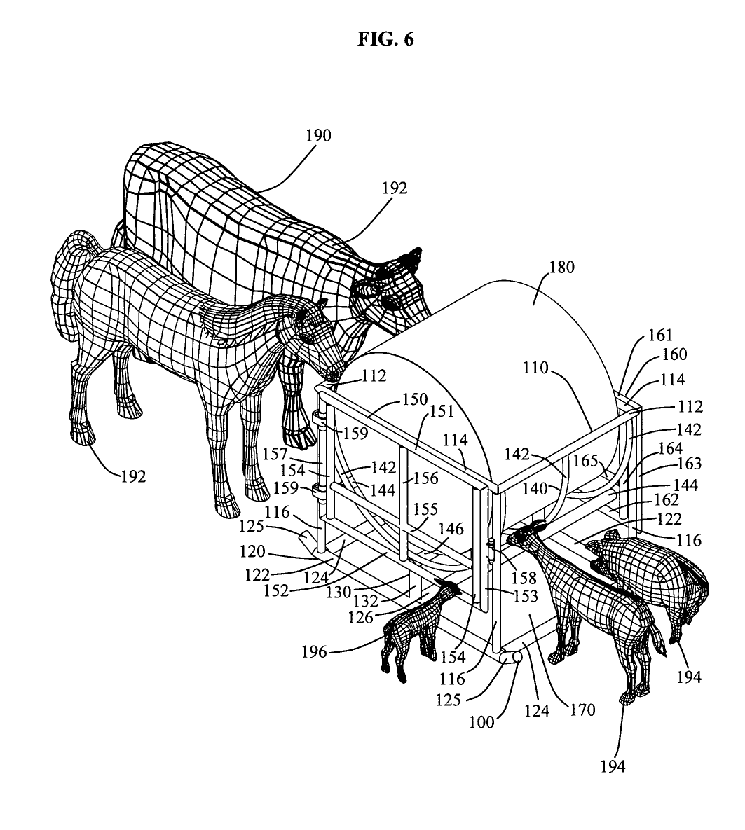

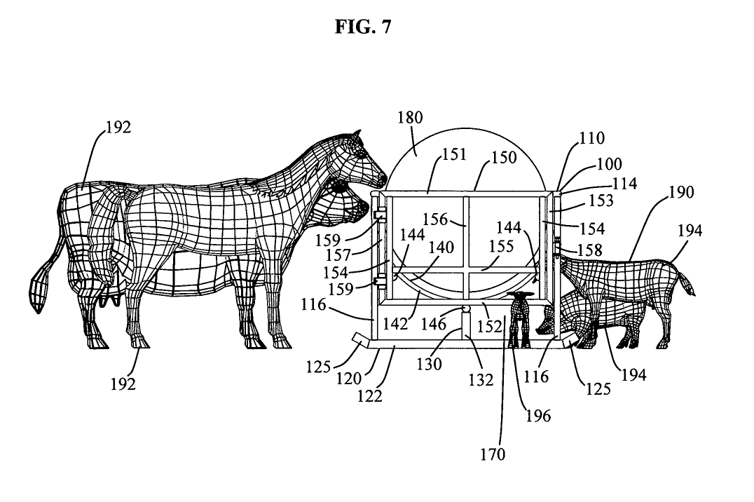

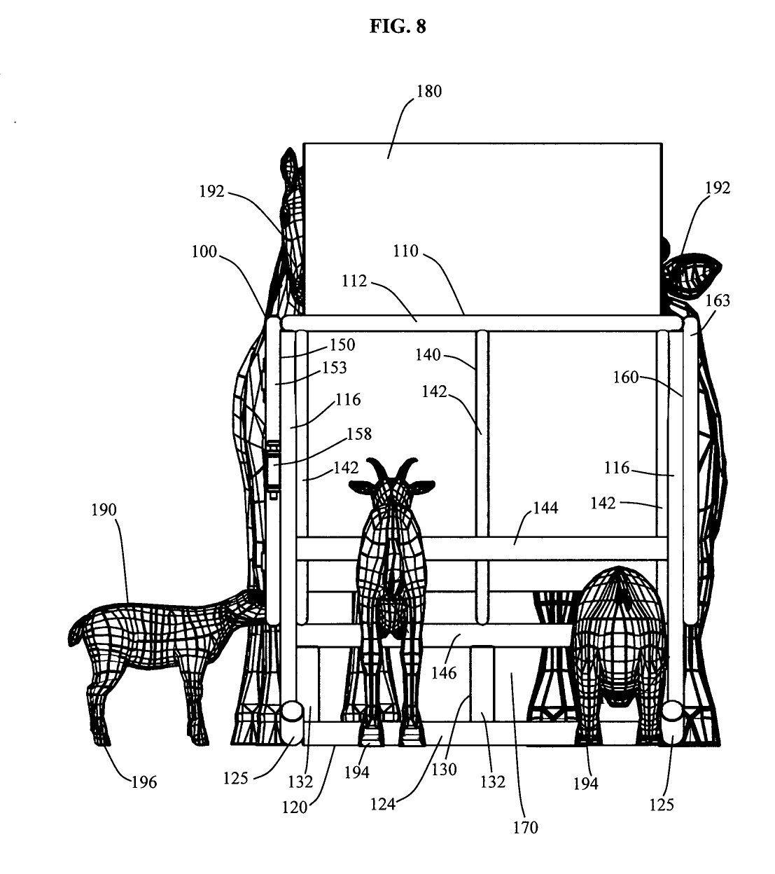

Referring now to the most preferred embodiment of the invention, in FIG. 1, FIG. 2, FIG. 3, FIG. 4, FIG. 5, FIG. 6, FIG. 7 and FIG. 8, a Single Round Bale Saddle Feeder 100 is shown. FIG. 1 illustrates a perspective view of a Single Round Bale Saddle Feeder 100. FIG. 2 depicts a front view of a Single Round Bale Saddle Feeder 100. FIG. 3 shows a rear view of a Single Round Bale Saddle Feeder 100. FIG. 4 displays a side view of a Single Round Bale Saddle Feeder 100. FIG. 5 shows a top view of a Single Round Bale Saddle Feeder 100. FIG. 6 depicts a perspective view of a Single Round Bale Saddle Feeder 100 loaded with a round hay bale 180 and showing livestock 190 feeding from the apparatus. FIG. 7 illustrates a front view of a Single Round Bale Saddle Feeder 100 loaded with a single round hay bale 180 and showing livestock 190 feeding from the apparatus. FIG. 8 demonstrates a side view of a Single Round Bale Saddle Feeder 100 loaded with a round hay bale 180 and showing livestock 190 feeding from the apparatus.

Referring still to the most preferred embodiment of the invention, in FIG. 1, FIG. 2, FIG. 3, FIG. 4, FIG. 5, FIG. 6, FIG. 7 and FIG. 8, a Single Round Bale Saddle Feeder 100 comprises a single bale outer frame 110; a single bale base 120, which supports the single bale outer frame 110; a single bale vertical support structure 130, which extends upward from the single bale base 120; and a single bale cradle 140, which is enclosed by the single bale outer frame 110, which is supported by the single bale vertical support structure 130, and which receives a single round hay bale 180. The single bale outer frame 110 comprises two single bale lengthwise rails 112; two single bale widthwise rails 114, which are perpendicular to the single bale lengthwise rails 112; four single bale vertical corner supports 116, which extend upward from the single bale base 120 and are perpendicular to both the single bale lengthwise rails 112 and the single bale widthwise rails 114; a single bale front gate 150, and a single bale rear panel 160. The single bale front gate 150 comprises a single bale gate top bar 151; a single bale gate bottom bar 152; a single bale gate outer latch bar 153; a single bale gate outer hinge bar 157; two single bale gate vertical inner support bars 154, which span between the single bale gate top bar 151 and the single bale gate bottom bar 152; a single bale gate horizontal cross bar 155, which spans between the two single bale gate vertical inner support bars 154; a single bale gate vertical cross bar 156, which spans between the center of the single bale gate top bar 151 and the center of the single bale gate bottom bar 152; two single bale gate hinges 159, which swingably connect the single bale gate outer hinge bar 157 to a single bale vertical corner support 116 on the front of the Single Round Bale Saddle Feeder 100; and a single bale gate latch 158, which lockably connects the single bale gate outer latch bar 153 to the other single bale vertical corner support 116 on the front of the Single Round Bale Saddle Feeder 100. The single bale rear panel 160 comprises a single bale panel top bar 161, which is connected to the single bale widthwise rail 114 on the rear of the Single Round Bale Saddle Feeder 100; a single bale panel bottom bar 162; two single bale panel outer bars 163, which are connected, respectively, to the two single bale vertical corner supports 116 on the rear of the Single Round Bale Saddle Feeder 100; two single bale panel vertical inner support bars 164, which span between the single bale panel top bar 161 and the single bale panel bottom bar 162; a single bale panel horizontal cross bar 165, which spans between the two single bale panel vertical inner support bars 164; a single bale panel vertical cross bar 166, which spans between the center of the single bale panel top bar 161 and the center of the single bale panel bottom bar 162. The single bale base 120 comprises two single bale widthwise base bars 122, which connect to the single bale vertical corner supports 116; single bale skids 125, which extend from the ends of the single bale widthwise base bars 122; two single bale lengthwise base bars 124, which span between the two single bale widthwise base bars 122 at the base of the single bale skids 125; and a single bale center base bar 126, which span between the center of the two single bale widthwise base bars 122. The single bale vertical support structure 130 comprises two single bale outer support columns 132, which extend upward from the centers of the two single bale widthwise base bars 122, and a single bale center support column 134, which extends upward from the center of the single bale center base bar 126. The single bale cradle 140 provides a framework for receiving and supporting a single round hay bale 180 and comprises a single bale center beam 146, which is supported at its ends by the two single bale outer support columns 132, and which is supported at its center by the single bale center support column 134; two single bale side beams 144, which span the length of the Single Round Bale Saddle Feeder 100 and plurality of single bale cradle ribs 142, which are curved in order to conform to the circumference of a round hay bale, which connect at their ends to the single bale lengthwise rails 112, and which connect to the two single bale side beams 144 and to the single bale center beam 146.

In further detail, referring still to the most preferred embodiment of the invention depicted in FIG. 1, FIG. 2, FIG. 3, FIG. 4, FIG. 5, FIG. 6, FIG. 7 and FIG. 8; in FIG. 6, FIG. 7 and FIG. 8, a series of images show livestock 190; including, but not limited to, large livestock 192, such as horses, cattle or the like; mid-sized livestock 192, such as mature pigs, goats or the like; and small livestock 196, such as young animals, calves, kids, piglets or the like; feeding on a round hay bale 180 loaded into a Single Round Bale Saddle Feeder 100. The arrangement of the structural elements of the Single Round Bale Saddle Feeder 100 provides feeding spaces for various types of livestock 190, which allow the animals to easily access a loaded round hay bale 180 while preventing the round hay bale from contacting the ground, thereby reducing the chances of the hay rotting or being wasted. The single bale small front feeding spaces 171 comprise the areas bounded by the single bale gate horizontal cross bar 155, the single bale gate vertical cross bar 156 and the single bale cradle rib 142 nearest to the front of the Single Round Bale Saddle Feeder 100, and allow mid-sized livestock 192 or small livestock 196 to access the round hay bale 180. The single bale large front feeding spaces 172 comprise the areas bounded by the single bale gate horizontal cross bar 155, the single bale gate vertical cross bar 156, the single bale gate top bar 151 and the single bale gate vertical inner support bar 154, and allow large livestock 192 to access the round hay bale 180. The single bale large front feeding spaces 172 substantially comply with the U.S. Department of Agriculture's recommended size for feeding cattle, which is two feet two inches (2′ 2″). The single bale small side feeding spaces 173 comprise the curved areas bounded by the single bale side beam 144, the single bale center beam 146 and two adjacent single bale cradle ribs 142, and allow mid-sized livestock 192 or small livestock 196 to access the round hay bale 180. The single bale large side feeding spaces 174 comprise the curved areas bounded by the single bale side beam 144, the single bale lengthwise rail 112 and two adjacent single bale cradle ribs 142, and allow large livestock 192 to access the round hay bale 180. The single bale large side feeding spaces 174 also substantially comply with the U.S. Department of Agriculture's recommended size for feeding cattle, which is two feet two inches (2′ 2″). The single bale small rear feeding space 177 comprise the areas bounded by the single bale panel horizontal cross bar 165, the single bale panel vertical cross bar 166 and the single bale cradle rib 142 nearest to the rear of the Single Round Bale Saddle Feeder 100, and allow mid-sized livestock 192 or small livestock 196 to access the round hay bale 180. The single bale large rear feeding spaces 178 comprise the areas bounded by the single bale panel horizontal cross bar 165, the single bale panel vertical cross bar 166, the single bale panel top bar 161 and the single bale panel vertical inner support bar 164, and allow large livestock 192 to access the round hay bale 180. The single bale large rear feeding spaces 178 also substantially comply with the U.S. Department of Agriculture's recommended size for feeding cattle, which is two feet two inches (2′ 2″). The single bale small animal feeding zones 170 comprise the space between the single bale base 120, the single bale vertical support structure 130, and the single bale cradle 140. In more detail, the single bale small animal feeding zones 170 comprise the volumes bounded by the single bale lengthwise base bar 124, the single bale widthwise base bars 122, the single bale center base bar 126, the single bale outer support columns 132, the single bale side beam 144, and the single bale center beam 146. The single bale small animal feeding zones 170 comprise the volumes that are substantially located directly under a loaded round hay bale 180 and provide a protected space for small livestock 196, such as young animals, calves, kids, piglets or the like, to feed from the underside of the loaded round hay bale 180 while being shielded from large livestock 192 that may be feeding from the sides of the loaded round hay bale 180, and effectively prevents the smaller animals from being trampled by the larger animals while the smaller animals simultaneously feed from the round hay bale 180. Further, by locating the support structure of the Single Round Bale Saddle Feeder 100 around the outer edge of the apparatus and by centering a load-bearing vertical support structure directly underneath the center of the single bale cradle 140, the single bale small animal feeding zones 170 are relatively free of obstacles or structural crossbars, which could present physical or visible barriers that would effectively discourage small animals from entering the volume and instead provide an optimized volume of protected space to encourage small livestock 196 to enter and safely feed under the loaded round hay bale 180.

The construction details of the invention as shown in FIG. 1, FIG. 2, FIG. 3, FIG. 4, FIG. 5, FIG. 6, FIG. 7, and FIG. 8, are as follows. The single bale lengthwise rails 112 comprise a strong, durable material, such as metal, steel, heavy gauge pipe, flat steel, wood, plastic, fiberglass, composite material or the like. The single bale widthwise rails 114 comprise a strong, durable material, such as metal, steel, heavy gauge pipe, flat steel, wood, plastic, fiberglass, composite material or the like. The single bale vertical corner supports 116 comprise a strong, durable material, such as metal, steel, heavy gauge pipe, flat steel, wood, plastic, fiberglass, composite material or the like. The single bale gate top bar 151 comprises a strong, durable material, such as metal, steel, heavy gauge pipe, flat steel, wood, plastic, fiberglass, composite material or the like. The single bale gate bottom bar 152 comprises a strong, durable material, such as metal, steel, heavy gauge pipe, flat steel, wood, plastic, fiberglass, composite material or the like. The single bale gate outer latch bar 153 comprises a strong, durable material, such as metal, steel, heavy gauge pipe, flat steel, wood, plastic, fiberglass, composite material or the like. The single bale gate outer hinge bar 157 comprises a strong, durable material, such as metal, steel, heavy gauge pipe, flat steel, wood, plastic, fiberglass, composite material or the like. The single bale gate vertical inner support bars 154 comprise a strong, durable material, such as metal, steel, heavy gauge pipe, flat steel, wood, plastic, fiberglass, composite material or the like. The single bale gate horizontal cross bar 155 comprises a strong, durable material, such as metal, steel, heavy gauge pipe, flat steel, wood, plastic, fiberglass, composite material or the like. The single bale gate vertical cross bar 156 comprises a strong, durable material, such as metal, steel, heavy gauge pipe, flat steel, wood, plastic, fiberglass, composite material or the like. The single bale gate hinges 159 comprise a strong, durable material, such as metal, steel, heavy gauge pipe, flat steel, wood, plastic, fiberglass, composite material or the like. The single bale gate latch 158 comprises a strong, durable material, such as metal, steel, heavy gauge pipe, flat steel, wood, plastic, fiberglass, composite material or the like. The single bale panel top bar 161 comprises a strong, durable material, such as metal, steel, heavy gauge pipe, flat steel, wood, plastic, fiberglass, composite material or the like. The single bale panel bottom bar 162 comprises a strong, durable material, such as metal, steel, heavy gauge pipe, flat steel, wood, plastic, fiberglass, composite material or the like. The single bale panel outer bars 163 comprise a strong, durable material, such as metal, steel, heavy gauge pipe, flat steel, wood, plastic, fiberglass, composite material or the like. The single bale panel vertical inner support bars 164 comprise a strong, durable material, such as metal, steel, heavy gauge pipe, flat steel, wood, plastic, fiberglass, composite material or the like. The single bale panel horizontal cross bar 165 comprises a strong, durable material, such as metal, steel, heavy gauge pipe, flat steel, wood, plastic, fiberglass, composite material or the like. The single bale panel vertical cross bar 166 comprises a strong, durable material, such as metal, steel, heavy gauge pipe, flat steel, wood, plastic, fiberglass, composite material or the like. The single bale widthwise base bars 122 comprise a strong, durable material, such as metal, steel, heavy gauge pipe, flat steel, wood, plastic, fiberglass, composite material or the like. The single bale skids 125 comprise a strong, durable material, such as metal, steel, heavy gauge pipe, flat steel, wood, plastic, fiberglass, composite material or the like. The single bale lengthwise base bars 124 comprise a strong, durable material, such as metal, steel, heavy gauge pipe, flat steel, wood, plastic, fiberglass, composite material or the like. The single bale center base bar 126 comprises a strong, durable material, such as metal, steel, heavy gauge pipe, flat steel, wood, plastic, fiberglass, composite material or the like. The single bale outer support columns 132 comprise a strong, durable material, such as metal, steel, heavy gauge pipe, flat steel, wood, plastic, fiberglass, composite material or the like. The single bale center support column 134 comprises a strong, durable material, such as metal, steel, heavy gauge pipe, flat steel, wood, plastic, fiberglass, composite material or the like. The single bale center beam 146 comprises a strong, durable material, such as metal, steel, heavy gauge pipe, flat steel, wood, plastic, fiberglass, composite material or the like. The single bale side beams 144 comprise a strong, durable material, such as metal, steel, heavy gauge pipe, flat steel, wood, plastic, fiberglass, composite material or the like. The single bale cradle ribs 142 comprise a strong, durable material, such as metal, steel, heavy gauge pipe, flat steel, wood, plastic, fiberglass, composite material or the like. The materials listed herein are examples only and not intended to limit the scope of the present invention.

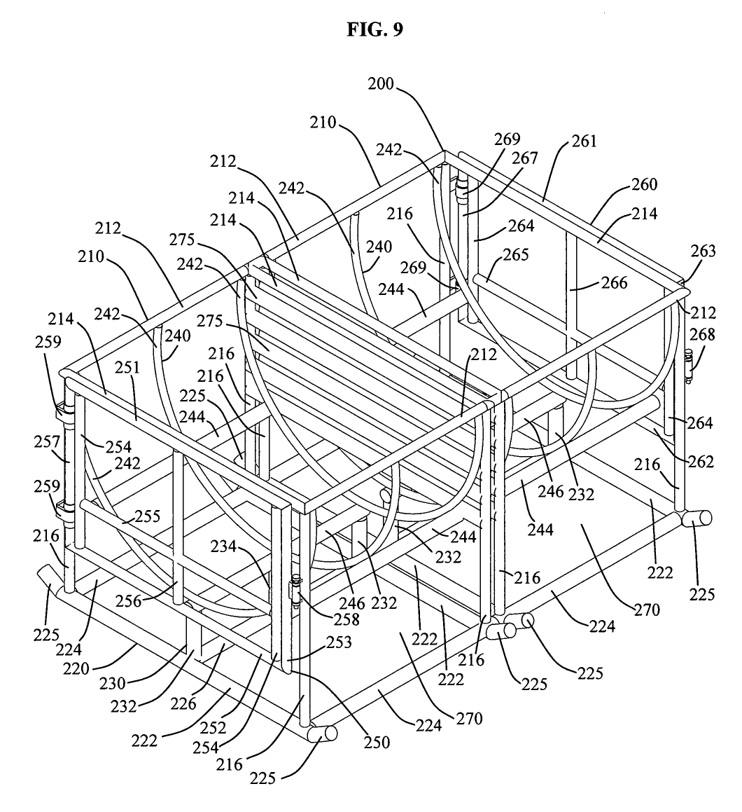

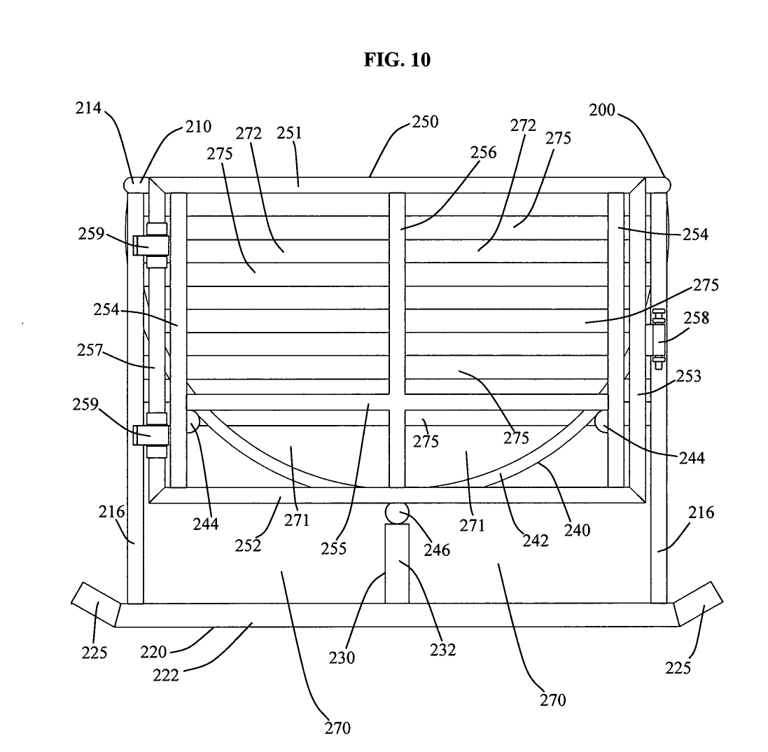

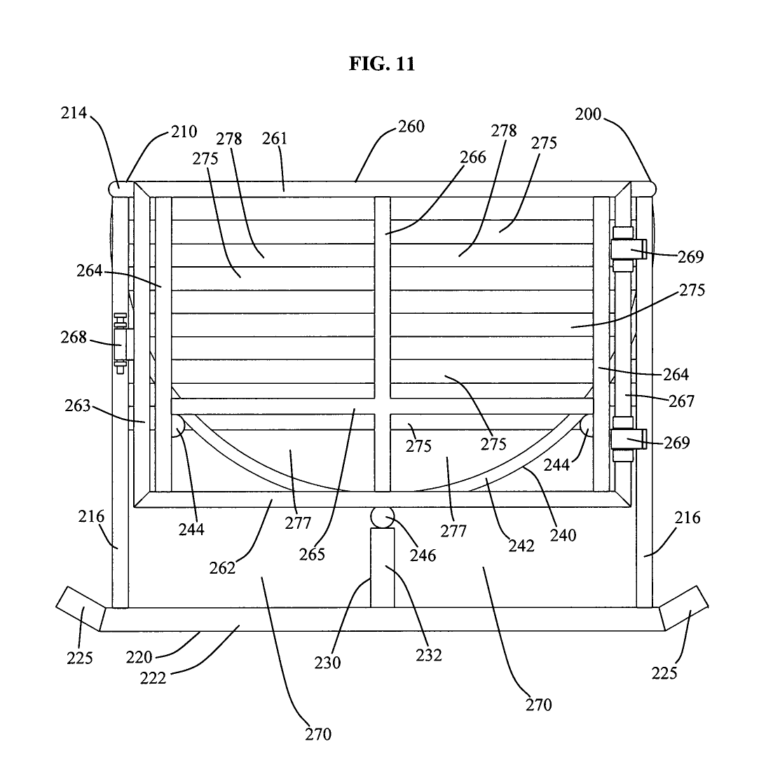

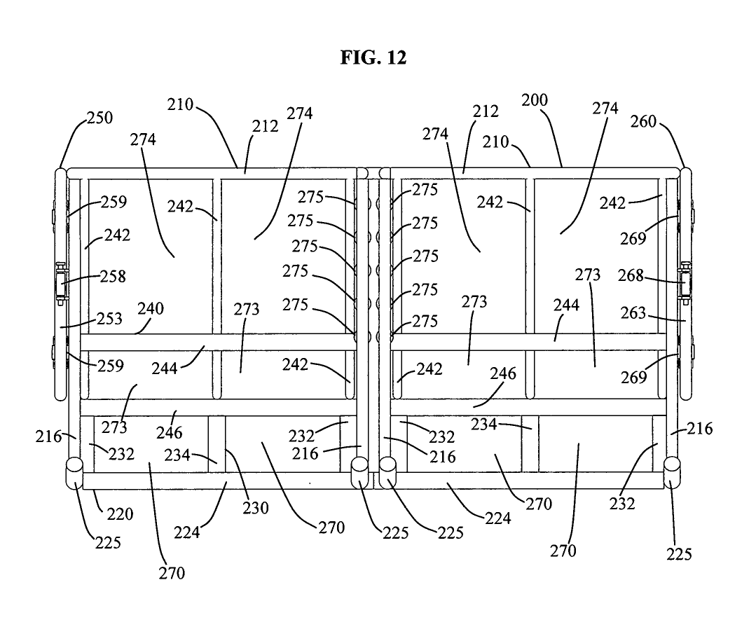

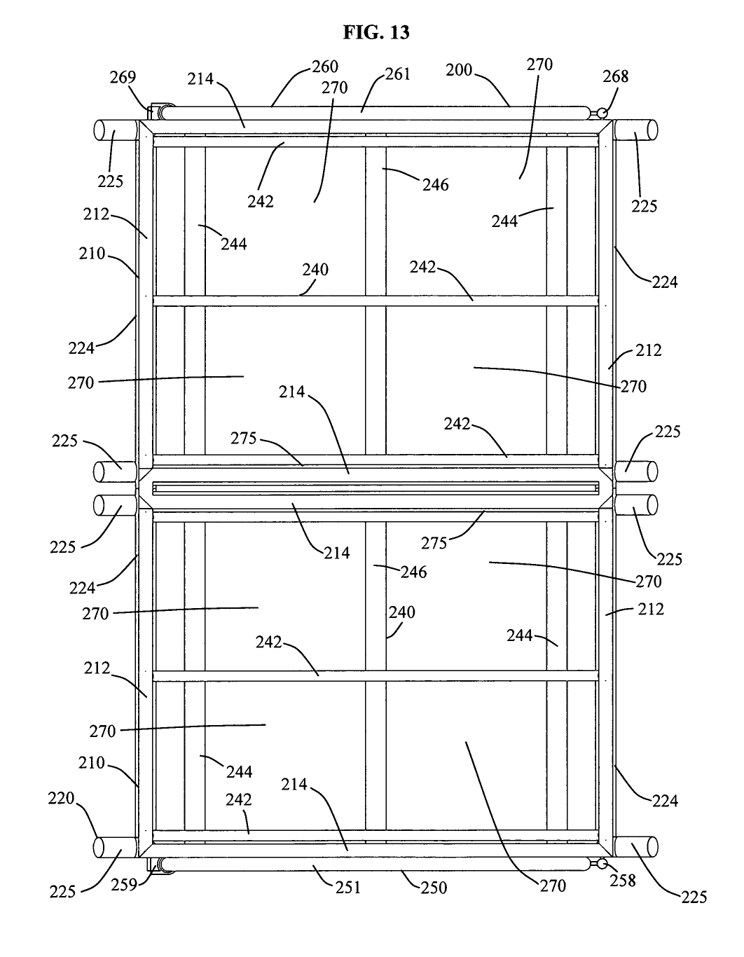

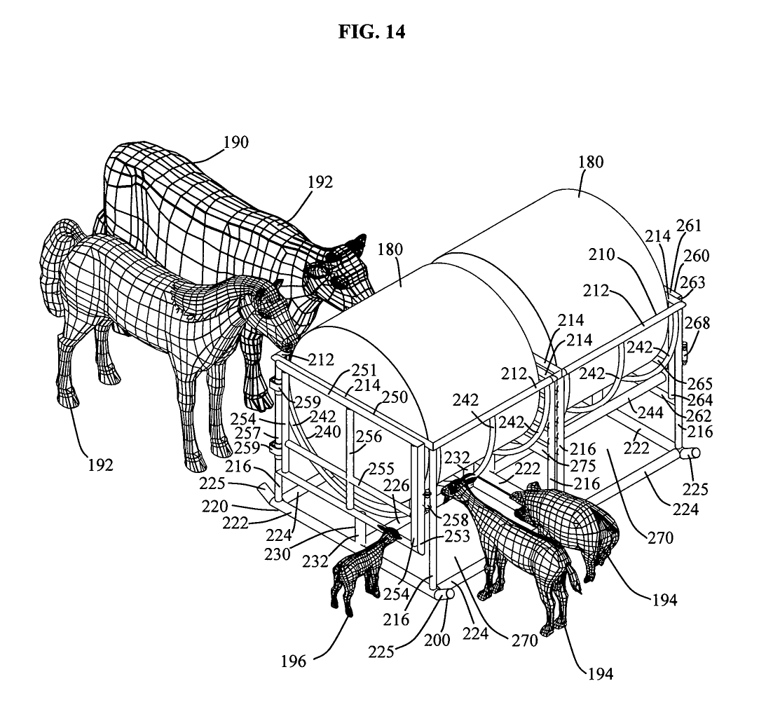

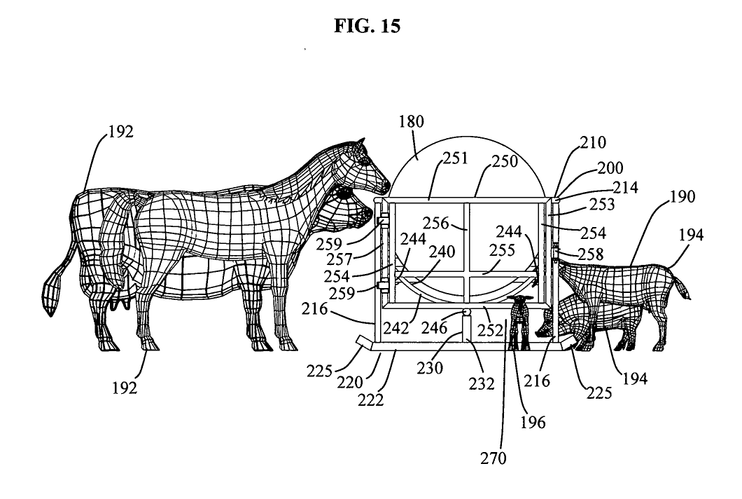

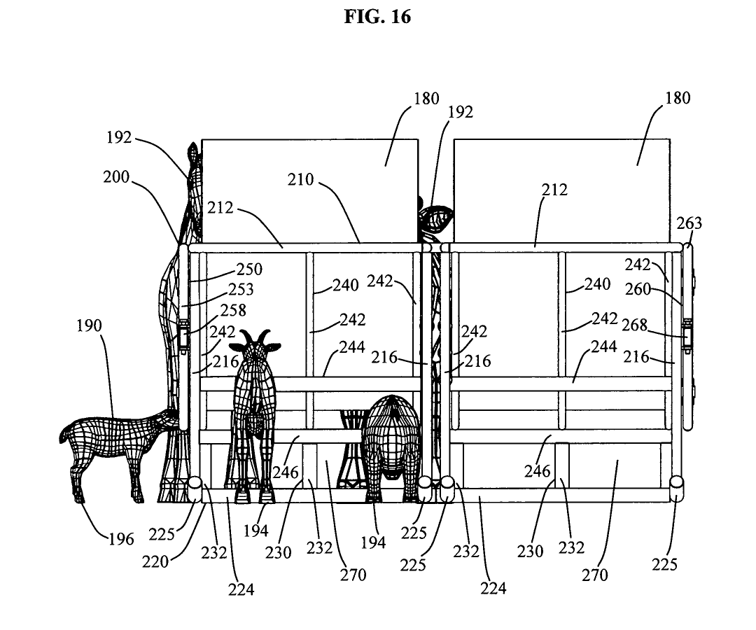

Referring now to another preferred embodiment of the invention, in FIG. 9, FIG. 10, FIG. 11, FIG. 12, FIG. 13, FIG. 14, FIG. 15, and FIG. 16, a Double Round Bale Saddle Feeder 200 is shown. FIG. 9 illustrates a perspective view of a Double Round Bale Saddle Feeder 200. FIG. 10 depicts a front view of a Double Round Bale Saddle Feeder 200. FIG. 11 shows a rear view of a Double Round Bale Saddle Feeder 200. FIG. 12 displays a side view of a Double Round Bale Saddle Feeder 200. FIG. 13 shows a top view of a Double Round Bale Saddle Feeder 200. FIG. 14 depicts a perspective view of a Double Round Bale Saddle Feeder 200 loaded with two round hay bales 180 and showing livestock 190 feeding from the apparatus. FIG. 15 illustrates a front view of a Double Round Bale Saddle Feeder 200 loaded with two round hay bales 180 and showing livestock 190 feeding from the apparatus. FIG. 16 demonstrates a side view of a Double Round Bale Saddle Feeder 200 loaded with two round hay bales 180 and showing livestock 190 feeding from the apparatus.

Referring still to the preferred embodiment of the invention in FIG. 9, FIG. 10, FIG. 11, FIG. 12, FIG. 13, FIG. 14, FIG. 15, and FIG. 16, a Double Round Bale Saddle Feeder 200 comprises two double bale outer frames 210; two double bale bases 220, which support the double bale outer frames 210; two double bale vertical support structures 230, which extends upward from the double bale bases 220; two double bale cradles 240, which are each enclosed by a double bale outer frame 210, which are each supported by a double bale vertical support structure 230, and which each receive a round hay bale 180; and a plurality of reinforcing bars 275, which span between the width of the Double Round Bale Saddle Feeder 200 and connect the two double bale outer frames 210 together. (Essentially, a Double Round Bale Saddle Feeder 200 substantially comprises two Single Bale Saddle Feeders 100, which are merged together by replacing the single bale rear panels 160 with a plurality of reinforcing bars 275 that connect the two Single Bale Saddle Feeders 100 together.) Each double bale outer frame 210 comprises two double bale lengthwise rails 212; two double bale widthwise rails 214, which are perpendicular to the double bale lengthwise rails 212; four double bale vertical supports 216, which extend upward from the double bale base 220 and are perpendicular to both the double bale lengthwise rails 212 and the double bale widthwise rails 214; a double bale front gate 250; and a double bale rear gate 260. The plurality of reinforcing bars 275 span the width of the Double Round Bale Saddle Feeder 200 and connect to the double bale vertical supports 216. The double bale front gate 250 comprises a double bale front gate top bar 251; a double bale front gate bottom bar 252; a double bale front gate outer latch bar 253; a double bale front gate outer hinge bar 257; two double bale front gate vertical inner support bars 254, which span between the double bale front gate top bar 251 and the double bale front gate bottom bar 252; a double bale front gate horizontal cross bar 255, which spans between the two double bale front gate vertical inner support bars 254; a double bale front gate vertical cross bar 256, which spans between the center of the double bale front gate top bar 251 and the center of the double bale front gate bottom bar 252; two double bale front gate hinges 259, which swingably connect the double bale front gate outer hinge bar 257 to a double bale vertical support 216 on the front of the Double Round Bale Saddle Feeder 200; and a double bale front gate latch 258, which lockably connects the double bale front gate outer latch bar 253 to the other double bale vertical support 216 on the front of the Double Round Bale Saddle Feeder 200. The double bale rear gate 260 comprises a double bale rear gate top bar 261; a double bale rear gate bottom bar 262; a double bale rear gate outer latch bar 263; a double bale rear gate outer hinge bar 267; two double bale rear gate vertical inner support bars 264, which span between the double bale rear gate top bar 261 and the double bale rear gate bottom bar 262; a double bale rear gate horizontal cross bar 265, which spans between the two double bale rear gate vertical inner support bars 264; a double bale rear gate vertical cross bar 266, which spans between the center of the double bale rear gate top bar 261 and the center of the double bale rear gate bottom bar 262; two double bale rear gate hinges 269, which swingably connect the double bale rear gate outer hinge bar 267 to a double bale vertical support 216 on the rear of the Double Round Bale Saddle Feeder 200; and a double bale rear gate latch 258, which lockably connects the double bale rear gate outer latch bar 253 to the other double bale vertical support 216 on the rear of the Double Round Bale Saddle Feeder 200. Each double bale base 220 comprises two double bale widthwise base bars 222, which connect to the double bale vertical supports 216; double bale skids 225, which extend from the ends of the double bale widthwise base bars 222; two double bale lengthwise base bars 224, which span between the double bale widthwise base bars 222 at the base of the double bale skids 225; and a double bale center base bar 226, which spans between the center of the two double bale widthwise base bars 222. Each double bale vertical support structure 230 comprises two double bale outer support columns 232, which extend upward from the centers of the double bale widthwise base bars 222, and a double bale center support column 234, which extends upward from the center of the double bale center base bar 226. Each double bale cradle 240 provides a framework for receiving and supporting a round hay bale 180 and comprises a double bale center beam 246, which is supported at its ends by the two double bale outer support columns 232, and which is supported at its center by the double bale center support column 234; two double bale side beams 244, which span the length of the double bale lengthwise rails 212; and plurality of double bale cradle ribs 242, which are curved in order to conform to the circumference of a round hay bale, which connect at their ends to the double bale lengthwise rails 212, and which connect to the two double bale side beams 244 and to the double bale center beam 246.

In further detail, referring still to the preferred embodiment of the invention depicted in FIG. 9, FIG. 10, FIG. 11, FIG. 12, FIG. 13, FIG. 14, FIG. 15, and FIG. 16; in FIG. 14, FIG. 15 and FIG. 16, a series of images show livestock 190; including, but not limited to, large livestock 192, such as horses, cattle or the like; mid-sized livestock 192, such as mature pigs, goats or the like; and small livestock 196, such as young animals, calves, kids, piglets or the like; feeding on a round hay bale 180 loaded into a Double Round Bale Saddle Feeder 200. The arrangement of the structural elements of the Double Round Bale Saddle Feeder 200 provides feeding spaces for various types of livestock 190, which allow the animals to easily access two loaded round hay bales 180 while preventing the round hay bale from contacting the ground, thereby reducing the chances of the hay rotting or being wasted. The double bale small front feeding spaces 271 comprise the areas bounded by the double bale front gate horizontal cross bar 255, the double bale front gate vertical cross bar 256 and the double bale cradle rib 242 nearest to the front of the Double Round Bale Saddle Feeder 200, and allow mid-sized livestock 192 or small livestock 196 to access a round hay bale 180. The double bale large front feeding spaces 272 comprise the areas bounded by the double bale front gate horizontal cross bar 255, the double bale front gate vertical cross bar 256, the double bale front gate top bar 251 and the double bale front gate vertical inner support bar 254, and allow large livestock 192 to access a round hay bale 180. The double bale large front feeding spaces 272 substantially comply with the U.S. Department of Agriculture's recommended size for feeding cattle, which is two feet two inches (2′ 2″). The double bale small side feeding spaces 273 comprise the curved areas bounded by the double bale side beam 244, the double bale center beam 246 and two adjacent double bale cradle ribs 242, and allow mid-sized livestock 192 or small livestock 196 to access a round hay bale 180. The double bale large side feeding spaces 274 comprise the curved areas bounded by the double bale side beam 244, the double bale lengthwise rail 212 and two adjacent double bale cradle ribs 242, and allow large livestock 192 to access a round hay bale 180. The double bale large side feeding spaces 274 also substantially comply with the U.S. Department of Agriculture's recommended size for feeding cattle, which is two feet two inches (2′ 2″). The double bale small rear feeding space 277 comprise the areas bounded by the double bale rear gate horizontal cross bar 265, the double bale rear gate vertical cross bar 266 and the double bale cradle rib 242 nearest to the rear of the Double Round Bale Saddle Feeder 200, and allow mid-sized livestock 192 or small livestock 196 to access a round hay bale 180. The double bale large rear feeding spaces 278 comprise the areas bounded by the double bale rear gate horizontal cross bar 265, the double bale rear gate vertical cross bar 266, the double bale rear gate top bar 261 and the double bale rear gate vertical inner support bar 264, and allow large livestock 192 to access a round hay bale 180. The double bale large rear feeding spaces 278 also substantially comply with the U.S. Department of Agriculture's recommended size for feeding cattle, which is two feet two inches (2′ 2″). The double bale small animal feeding zones 270 comprise the spaces between the double bale bases 220, the double bale vertical support structures 230, and the double bale cradles 240. In more detail, the double bale small animal feeding zones 270 comprise the volumes bounded by the double bale lengthwise base bar 224, the double bale widthwise base bars 222, the double bale center base bar 226, the double bale outer support columns 232, the double bale side beam 244, and the double bale center beam 246. The double bale small animal feeding zones 270 comprise the volumes that are substantially located directly under the two loaded round hay bales 180 and provide a protected space for small livestock 196, such as young animals, calves, kids, piglets or the like, to feed from the underside of the two loaded round hay bales 180 while being shielded from large livestock 192 that may be feeding from the sides of the two loaded round hay bales 180, and effectively prevents the smaller animals from being trampled by the larger animals while the smaller animals simultaneously feed from a round hay bale 180. Further, by locating the support structure of the Double Round Bale Saddle Feeder 200 around the outer edge of the apparatus and by centering a load-bearing vertical support structure directly underneath the center of the double bale cradle 240, the double bale small animal feeding zones 270 are relatively free of obstacles or structural crossbars, which could present physical or visible barriers that would effectively discourage small animals from entering the volume and instead provide an optimized volume of protected space to encourage small livestock 196 to enter and safely feed under a loaded round hay bale 180.

The construction details of the invention as shown in FIG. 9, FIG. 10, FIG. 11, FIG. 12, FIG. 13, FIG. 14, FIG. 15, and FIG. 16, are as follows. The double bale lengthwise rails 212 comprise a strong, durable material, such as metal, steel, heavy gauge pipe, flat steel, wood, plastic, fiberglass, composite material or the like. The double bale widthwise rails 214 comprise a strong, durable material, such as metal, steel, heavy gauge pipe, flat steel, wood, plastic, fiberglass, composite material or the like. The double bale vertical supports 216 comprise a strong, durable material, such as metal, steel, heavy gauge pipe, flat steel, wood, plastic, fiberglass, composite material or the like. The double bale front gate top bar 251 comprises a strong, durable material, such as metal, steel, heavy gauge pipe, flat steel, wood, plastic, fiberglass, composite material or the like. The double bale front gate bottom bar 252 comprises a strong, durable material, such as metal, steel, heavy gauge pipe, flat steel, wood, plastic, fiberglass, composite material or the like. The double bale front gate outer latch bar 253 comprises a strong, durable material, such as metal, steel, heavy gauge pipe, flat steel, wood, plastic, fiberglass, composite material or the like. The double bale front gate outer hinge bar 257 comprises a strong, durable material, such as metal, steel, heavy gauge pipe, flat steel, wood, plastic, fiberglass, composite material or the like. The double bale front gate vertical inner support bars 254 comprise a strong, durable material, such as metal, steel, heavy gauge pipe, flat steel, wood, plastic, fiberglass, composite material or the like. The double bale front gate horizontal cross bar 255 comprises a strong, durable material, such as metal, steel, heavy gauge pipe, flat steel, wood, plastic, fiberglass, composite material or the like. The double bale front gate vertical cross bar 256 comprises a strong, durable material, such as metal, steel, heavy gauge pipe, flat steel, wood, plastic, fiberglass, composite material or the like. The double bale front gate hinges 259 comprise a strong, durable material, such as metal, steel, heavy gauge pipe, flat steel, wood, plastic, fiberglass, composite material or the like. The double bale front gate latch 258 comprises a strong, durable material, such as metal, steel, heavy gauge pipe, flat steel, wood, plastic, fiberglass, composite material or the like. The double bale rear gate top bar 261 comprises a strong, durable material, such as metal, steel, heavy gauge pipe, flat steel, wood, plastic, fiberglass, composite material or the like. The double bale rear gate bottom bar 262 comprises a strong, durable material, such as metal, steel, heavy gauge pipe, flat steel, wood, plastic, fiberglass, composite material or the like. The double bale rear gate outer latch bar 263 comprises a strong, durable material, such as metal, steel, heavy gauge pipe, flat steel, wood, plastic, fiberglass, composite material or the like. The double bale rear gate outer hinge bar 267 comprises a strong, durable material, such as metal, steel, heavy gauge pipe, flat steel, wood, plastic, fiberglass, composite material or the like. The double bale rear gate vertical inner support bars 264 comprise a strong, durable material, such as metal, steel, heavy gauge pipe, flat steel, wood, plastic, fiberglass, composite material or the like. The double bale rear gate horizontal cross bar 265 comprises a strong, durable material, such as metal, steel, heavy gauge pipe, flat steel, wood, plastic, fiberglass, composite material or the like. The double bale rear gate vertical cross bar 266 comprises a strong, durable material, such as metal, steel, heavy gauge pipe, flat steel, wood, plastic, fiberglass, composite material or the like. The double bale rear gate hinges 269 comprise a strong, durable material, such as metal, steel, heavy gauge pipe, flat steel, wood, plastic, fiberglass, composite material or the like. The double bale rear gate latch 268 comprises a strong, durable material, such as metal, steel, heavy gauge pipe, flat steel, wood, plastic, fiberglass, composite material or the like. The double bale widthwise base bars 222 comprise a strong, durable material, such as metal, steel, heavy gauge pipe, flat steel, wood, plastic, fiberglass, composite material or the like. The double bale skids 225 comprise a strong, durable material, such as metal, steel, heavy gauge pipe, flat steel, wood, plastic, fiberglass, composite material or the like. The double bale lengthwise base bars 224 comprise a strong, durable material, such as metal, steel, heavy gauge pipe, flat steel, wood, plastic, fiberglass, composite material or the like. The double bale center base bars 226 comprise a strong, durable material, such as metal, steel, heavy gauge pipe, flat steel, wood, plastic, fiberglass, composite material or the like. The double bale outer support columns 232 comprise a strong, durable material, such as metal, steel, heavy gauge pipe, flat steel, wood, plastic, fiberglass, composite material or the like. The double bale center support columns 234 comprise a strong, durable material, such as metal, steel, heavy gauge pipe, flat steel, wood, plastic, fiberglass, composite material or the like. The double bale center beams 246 comprise a strong, durable material, such as metal, steel, heavy gauge pipe, flat steel, wood, plastic, fiberglass, composite material or the like. The double bale side beams 244 comprise a strong, durable material, such as metal, steel, heavy gauge pipe, flat steel, wood, plastic, fiberglass, composite material or the like. The double bale cradle ribs 242 comprise a strong, durable material, such as metal, steel, heavy gauge pipe, flat steel, wood, plastic, fiberglass, composite material or the like. The materials listed herein are examples only and not intended to limit the scope of the present invention.

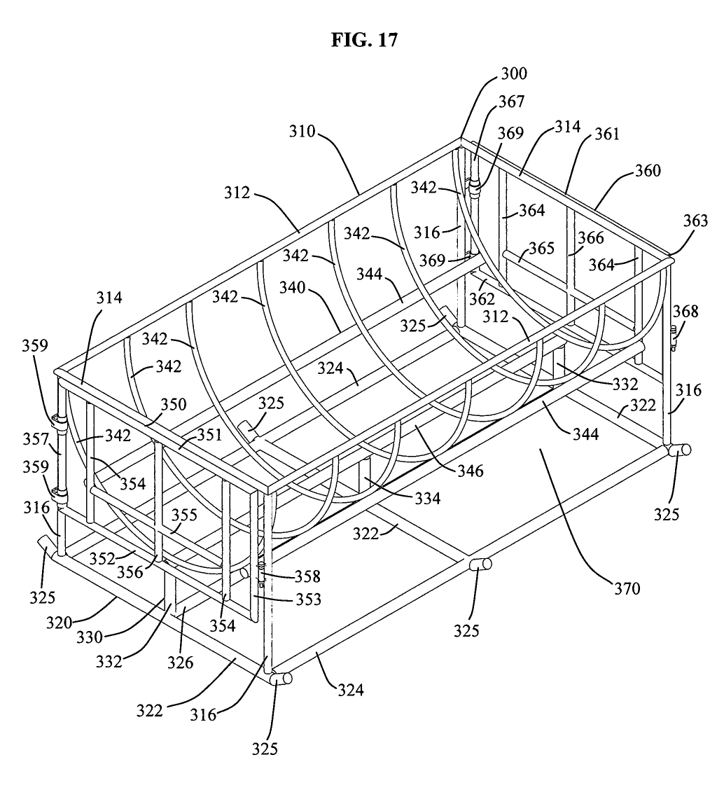

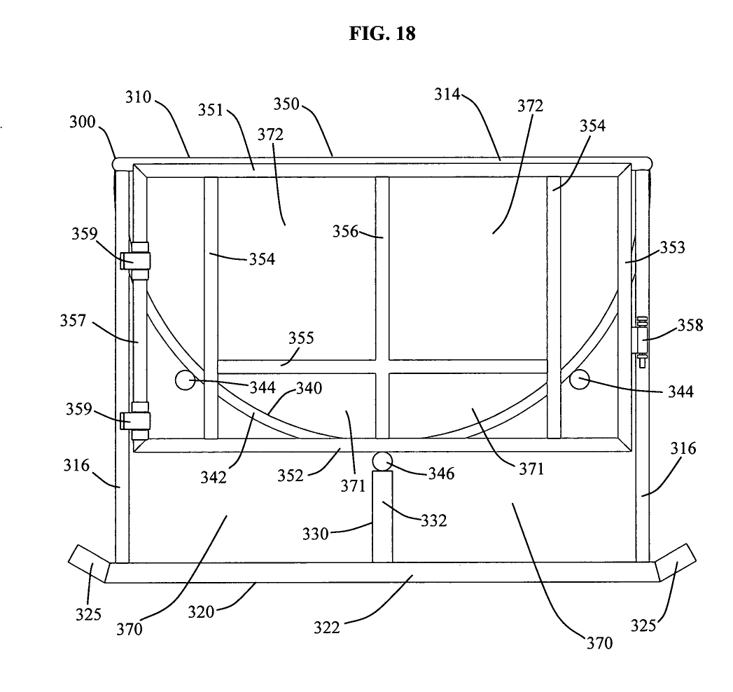

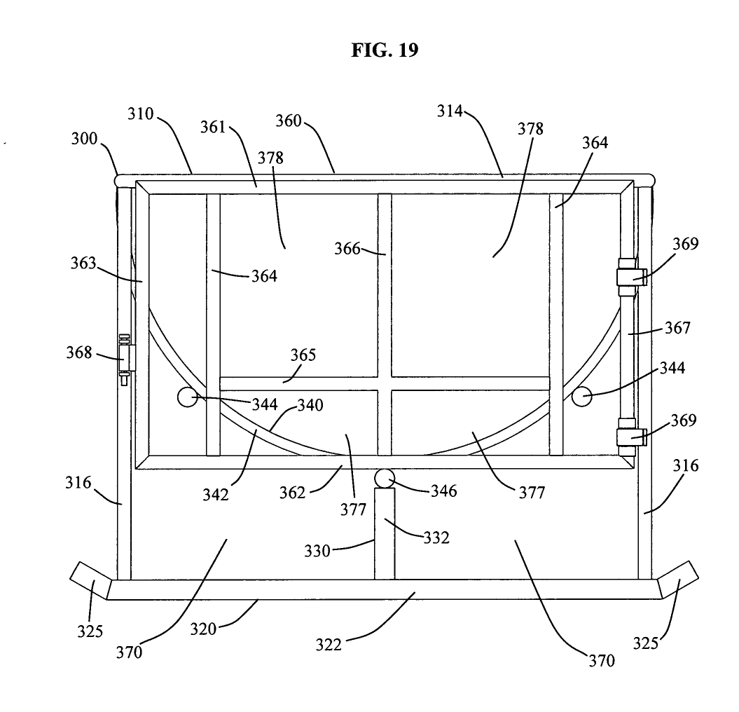

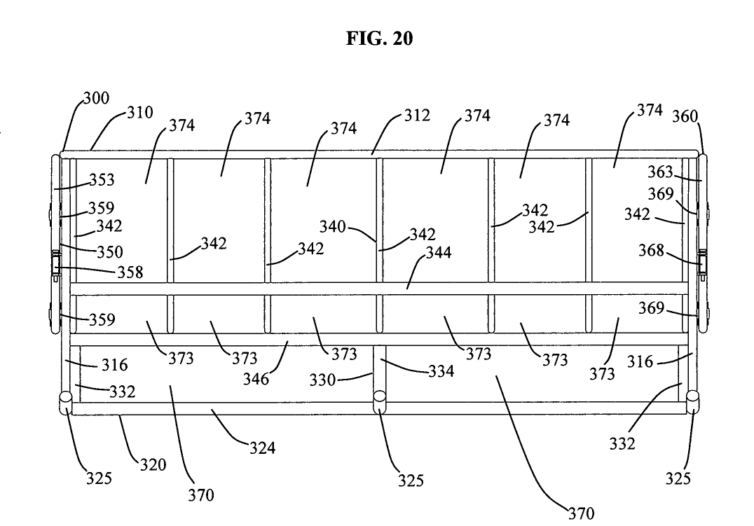

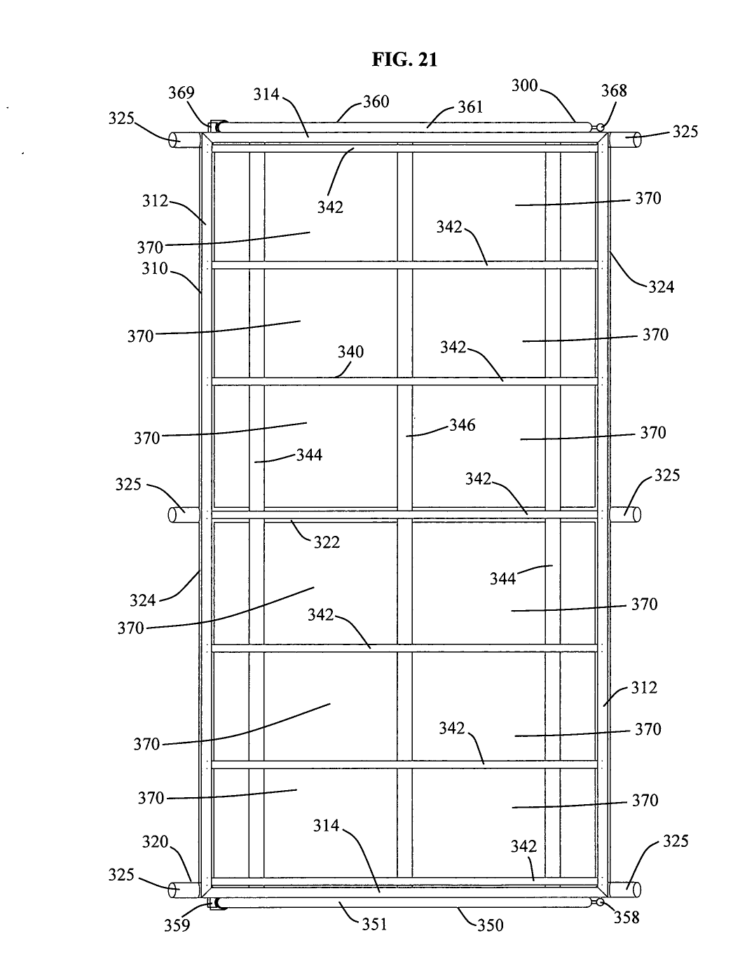

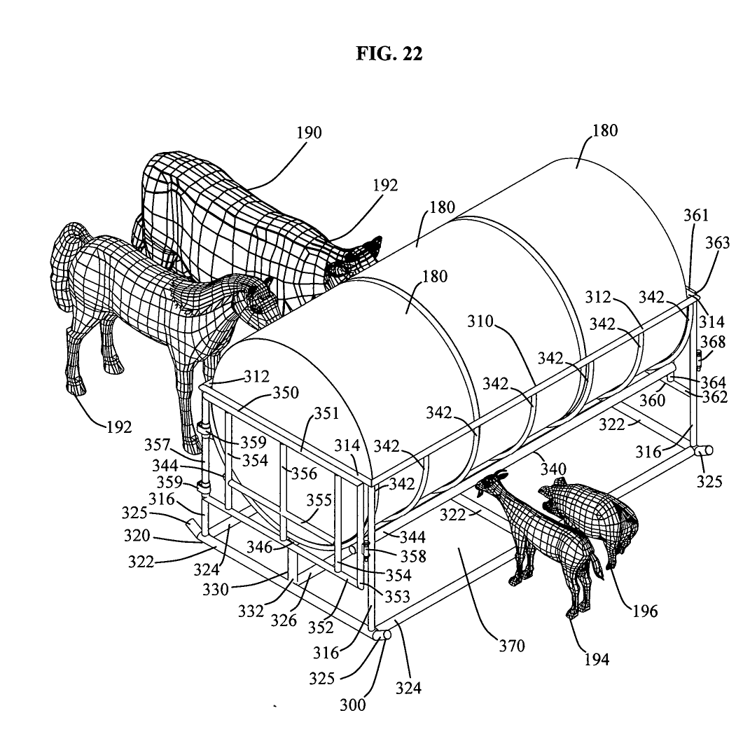

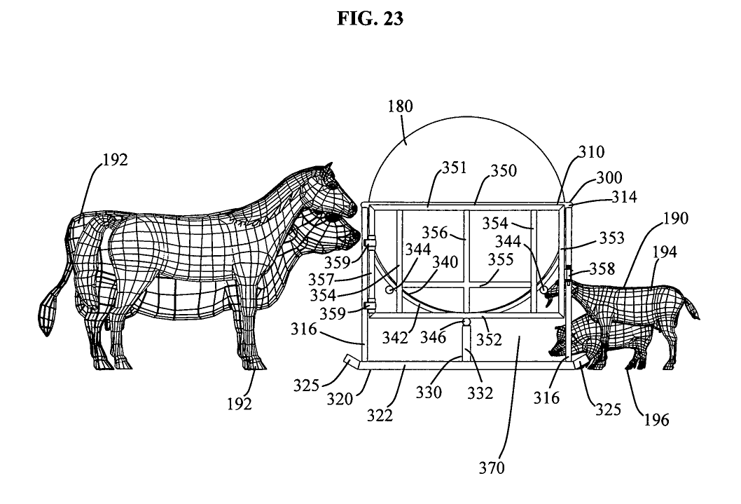

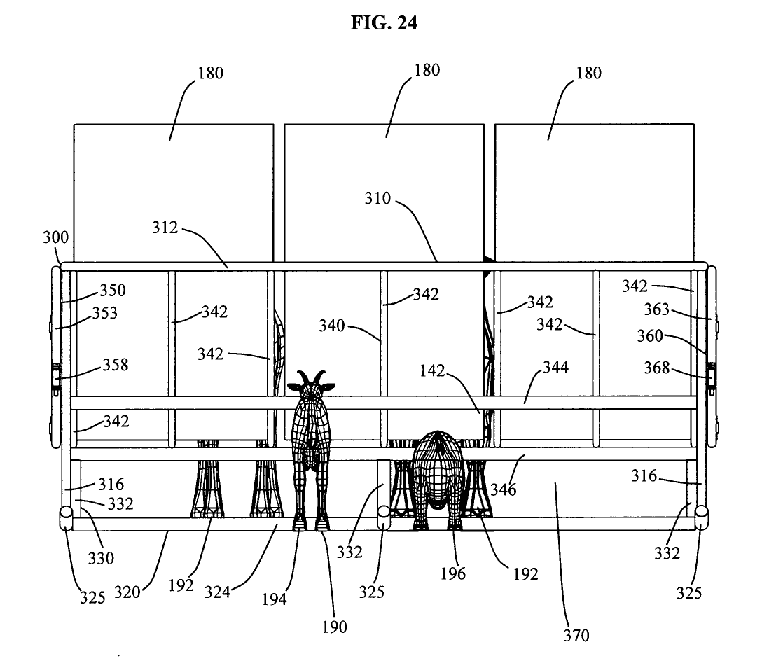

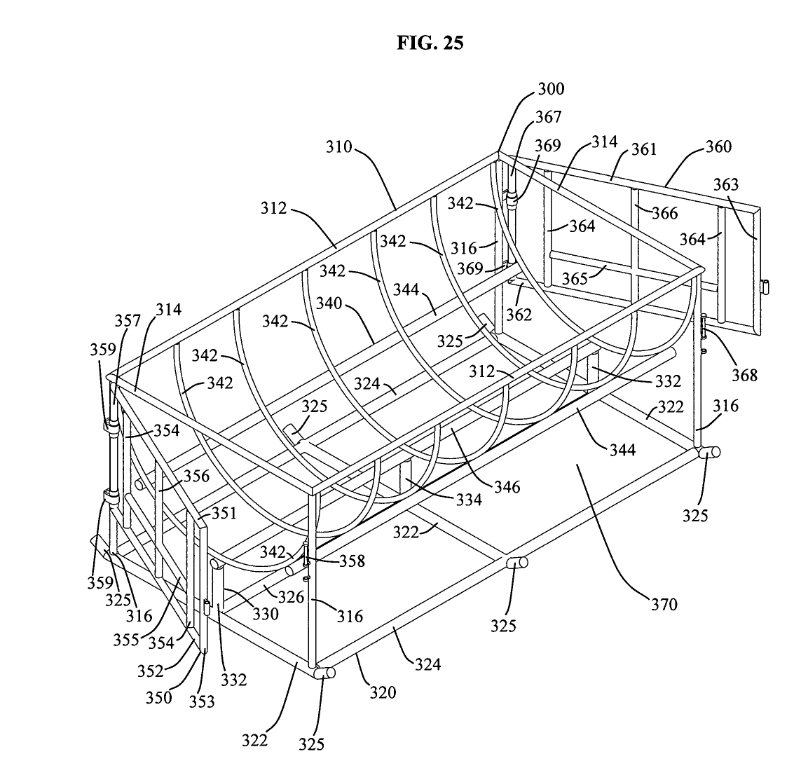

Referring now to another preferred embodiment of the invention, in FIG. 17, FIG. 18, FIG. 19, FIG. 20, FIG. 21, FIG. 22, FIG. 23, FIG. 24, and FIG. 25, a Triple Round Bale Saddle Feeder 300 is shown. FIG. 17 illustrates a perspective view of a Triple Round Bale Saddle Feeder 300. FIG. 18 depicts a front view of a Triple Round Bale Saddle Feeder 300. FIG. 19 shows a rear view of a Triple Round Bale Saddle Feeder 300. FIG. 20 displays a side view of a Triple Round Bale Saddle Feeder 300. FIG. 21 shows a top view of a Triple Round Bale Saddle Feeder 300. FIG. 22 depicts a perspective view of a Triple Round Bale Saddle Feeder 300 loaded with a round hay bale 180 and showing livestock 190 feeding from the apparatus. FIG. 23 illustrates a front view of a Triple Round Bale Saddle Feeder 300 loaded with a three round hay bales 180 and showing livestock 190 feeding from the apparatus. FIG. 24 demonstrates a side view of a Triple Round Bale Saddle Feeder 300 loaded with a round hay bale 180 and showing livestock 190 feeding from the apparatus. FIG. 25 illustrates a perspective view of a Triple Round Bale Saddle Feeder 300 showing both the front gate and the rear gate in an open position.

Referring still to the preferred embodiment of the invention in FIG. 17, FIG. 18, FIG. 19, FIG. 20, FIG. 21, FIG. 22, FIG. 23, FIG. 24, and FIG. 25, a Triple Round Bale Saddle Feeder 300 comprises a triple bale outer frame 310; a triple bale base 320, which supports the triple bale outer frame 310; a triple bale vertical support structure 330, which extends upward from the triple bale base 320; a triple bale cradle 340, which is enclosed by the triple bale outer frame 310, which is supported by the triple bale vertical support structure 330, and which receives a triple round hay bale 380. The triple bale outer frame 310 comprises two triple bale lengthwise rails 312, which span the length of the Triple Round Bale Saddle Feeder 300; two triple bale widthwise rails 314, which are perpendicular to the triple bale lengthwise rails 312 and which span the width of the Triple Round Bale Saddle Feeder 300; four triple bale vertical corner supports 316, which extend upward from the triple bale base 320 and are perpendicular to both the triple bale lengthwise rails 312 and the triple bale widthwise rails 314; a triple bale front gate 350, and a triple bale rear gate 360. The triple bale front gate 350 comprises a triple bale front gate top bar 351; a triple bale front gate bottom bar 352; a triple bale front gate outer latch bar 353; a triple bale front gate outer hinge bar 357; two triple bale front gate vertical inner support bars 354, which span between the triple bale front gate top bar 351 and the triple bale front gate bottom bar 352; a triple bale front gate horizontal cross bar 355, which spans between the two triple bale front gate vertical inner support bars 354; a triple bale front gate vertical cross bar 356, which spans between the center of the triple bale front gate top bar 351 and the center of the triple bale front gate bottom bar 352; two triple bale front gate hinges 359, which swingably connect the triple bale front gate outer hinge bar 357 to a triple bale vertical corner support 316 on the front of the Triple Round Bale Saddle Feeder 300; and a triple bale front gate latch 358, which lockably connects the triple bale front gate outer latch bar 353 to the other triple bale vertical corner support 316 on the front of the Triple Round Bale Saddle Feeder 300. The triple bale rear gate 360 comprises a triple bale rear gate top bar 361; a triple bale rear gate bottom bar 362; a triple bale rear gate outer latch bar 363; a triple bale rear gate outer hinge bar 367; two triple bale rear gate vertical inner support bars 364, which span between the triple bale rear gate top bar 361 and the triple bale rear gate bottom bar 362; a triple bale rear gate horizontal cross bar 365, which spans between the two triple bale rear gate vertical inner support bars 364; a triple bale rear gate vertical cross bar 366, which spans between the center of the triple bale rear gate top bar 361 and the center of the triple bale rear gate bottom bar 362; two triple bale rear gate hinges 369, which swingably connect the triple bale rear gate outer hinge bar 367 to a triple bale vertical corner support 316 on the rear of the Triple Round Bale Saddle Feeder 300; and a triple bale rear gate latch 368, which lockably connects the triple bale rear gate outer latch bar 363 to the other triple bale vertical corner support 316 on the rear of the Triple Round Bale Saddle Feeder 300. The triple bale base 320 comprises two triple bale widthwise base bars 322, which span the width of the Triple Round Bale Saddle Feeder 300 and connect to the triple bale vertical corner supports 316; triple bale skids 325, which extend from the ends of the triple bale widthwise base bars 322; two triple bale lengthwise base bars 324, which span the length of the Triple Round Bale Saddle Feeder 300 between the two triple bale widthwise base bars 322 at the base of the triple bale skids 325; and a triple bale center base bar 326, which span between the center of the two triple bale widthwise base bars 322. The triple bale vertical support structure 330 comprises two triple bale outer support columns 332, which extend upward from the centers of the two triple bale widthwise base bars 322, and a triple bale center support column 334, which extends upward from the center of the triple bale center base bar 326. The triple bale cradle 340 provides a framework for receiving and supporting three round hay bales 180 and comprises a triple bale center beam 346, which is supported at its ends by the two triple bale outer support columns 332, and which is supported at its center by the triple bale center support column 334; two triple bale side beams 344, which span the length of the Triple Round Bale Saddle Feeder 300 and plurality of triple bale cradle ribs 342, which are curved in order to conform to the circumference of a round hay bale, which connect at their ends to the triple bale lengthwise rails 312, and which connect to the two triple bale side beams 344 and to the triple bale center beam 346.

In further detail, referring still to the most preferred embodiment of the invention depicted in FIG. 17, FIG. 18, FIG. 19, FIG. 20, FIG. 21, FIG. 22, FIG. 23, FIG. 24, and FIG. 25; in FIG. 22, FIG. 23 and FIG. 24, a series of images show livestock 190; including, but not limited to, large livestock 192, such as horses, cattle or the like; mid-sized livestock 192, such as mature pigs, goats or the like; and small livestock 196, such as young animals, calves, kids, piglets or the like; feeding on three round hay bales 180 loaded into a Triple Round Bale Saddle Feeder 300. The arrangement of the structural elements of the Triple Round Bale Saddle Feeder 300 provides feeding spaces for various types of livestock 190, which allow the animals to easily access three loaded round hay bales 180 while preventing the round hay bale from contacting the ground, thereby reducing the chances of the hay rotting or being wasted. The triple bale small front feeding spaces 371 comprise the areas bounded by the triple bale gate horizontal cross bar 355, the triple bale gate vertical cross bar 356 and the triple bale cradle rib 342 nearest to the front of the Triple Round Bale Saddle Feeder 300, and allow mid-sized livestock 192 or small livestock 196 to access a round hay bale 180. The triple bale large front feeding spaces 372 comprise the areas bounded by the triple bale gate horizontal cross bar 355, the triple bale gate vertical cross bar 356, the triple bale gate top bar 351 and the triple bale gate vertical inner support bar 354, and allow large livestock 192 to access a round hay bale 180. The triple bale large front feeding spaces 372 substantially comply with the U.S. Department of Agriculture's recommended size for feeding cattle, which is two feet two inches (2′ 2″). The triple bale small side feeding spaces 373 comprise the curved areas bounded by the triple bale side beam 344, the triple bale center beam 346 and two adjacent triple bale cradle ribs 342, and allow mid-sized livestock 192 or small livestock 196 to access a round hay bale 180. The triple bale large side feeding spaces 374 comprise the curved areas bounded by the triple bale side beam 344, the triple bale lengthwise rail 312 and two adjacent triple bale cradle ribs 342, and allow large livestock 192 to access a round hay bale 180. The triple bale large side feeding spaces 374 also substantially comply with the U.S. Department of Agriculture's recommended size for feeding cattle, which is two feet two inches (2′ 2″). The triple bale small rear feeding space 377 comprise the areas bounded by the triple bale rear gate horizontal cross bar 365, the triple bale rear gate vertical cross bar 366 and the triple bale cradle rib 342 nearest to the rear of the Triple Round Bale Saddle Feeder 300, and allow mid-sized livestock 192 or small livestock 196 to access the round hay bale 180. The triple bale large rear feeding spaces 378 comprise the areas bounded by the triple bale rear gate horizontal cross bar 365, the triple bale rear gate vertical cross bar 366, the triple bale rear gate top bar 361 and the triple bale rear gate vertical inner support bar 364, and allow large livestock 192 to access the round hay bale 180. The triple bale large rear feeding spaces 378 also substantially comply with the U.S. Department of Agriculture's recommended size for feeding cattle, which is two feet two inches (2′ 2″). The triple bale small animal feeding zones 370 comprise the space between the triple bale base 320, the triple bale vertical support structure 330, and the triple bale cradle 340. In more detail, the triple bale small animal feeding zones 370 comprise the volumes bounded by the triple bale lengthwise base bar 324, the triple bale widthwise base bars 322, the triple bale center base bar 326, the triple bale outer support columns 332, the triple bale side beam 344, and the triple bale center beam 346. The triple bale small animal feeding zones 370 comprise the volumes that are substantially located directly under the three loaded round hay bales 180 and provide a protected space for small livestock 196, such as young animals, calves, kids, piglets or the like, to feed from the underside of the three loaded round hay bales 180 while being shielded from large livestock 192 that may be feeding from the sides of the loaded round hay bale 180, and effectively prevents the smaller animals from being trampled by the larger animals while the smaller animals simultaneously feed from the round hay bale 180. Further, by locating the support structure of the Triple Round Bale Saddle Feeder 300 around the outer edge of the apparatus and by centering a load-bearing vertical support structure directly underneath the center of the triple bale cradle 340, the triple bale small animal feeding zones 370 are relatively free of obstacles or structural crossbars, which could present physical or visible barriers that would effectively discourage small animals from entering the volume and instead provide an optimized volume of protected space to encourage small livestock 196 to enter and safely feed under the three loaded round hay bales 180.

The construction details of the invention as shown in FIG. 17, FIG. 18, FIG. 19, FIG. 20, FIG. 21, FIG. 22, FIG. 23, FIG. 24, and FIG. 25, are as follows. The triple bale lengthwise rails 312 comprise a strong, durable material, such as metal, steel, heavy gauge pipe, flat steel, wood, plastic, fiberglass, composite material or the like. The triple bale widthwise rails 314 comprise a strong, durable material, such as metal, steel, heavy gauge pipe, flat steel, wood, plastic, fiberglass, composite material or the like. The triple bale vertical corner supports 316 comprise a strong, durable material, such as metal, steel, heavy gauge pipe, flat steel, wood, plastic, fiberglass, composite material or the like. The triple bale front gate top bar 351 comprises a strong, durable material, such as metal, steel, heavy gauge pipe, flat steel, wood, plastic, fiberglass, composite material or the like. The triple bale front gate bottom bar 352 comprises a strong, durable material, such as metal, steel, heavy gauge pipe, flat steel, wood, plastic, fiberglass, composite material or the like. The triple bale front gate outer latch bar 353 comprises a strong, durable material, such as metal, steel, heavy gauge pipe, flat steel, wood, plastic, fiberglass, composite material or the like. The triple bale front gate outer hinge bar 357 comprises a strong, durable material, such as metal, steel, heavy gauge pipe, flat steel, wood, plastic, fiberglass, composite material or the like. The triple bale front gate vertical inner support bars 354 comprise a strong, durable material, such as metal, steel, heavy gauge pipe, flat steel, wood, plastic, fiberglass, composite material or the like. The triple bale front gate horizontal cross bar 355 comprises a strong, durable material, such as metal, steel, heavy gauge pipe, flat steel, wood, plastic, fiberglass, composite material or the like. The triple bale front gate vertical cross bar 356 comprises a strong, durable material, such as metal, steel, heavy gauge pipe, flat steel, wood, plastic, fiberglass, composite material or the like. The triple bale front gate hinges 359 comprise a strong, durable material, such as metal, steel, heavy gauge pipe, flat steel, wood, plastic, fiberglass, composite material or the like. The triple bale front gate latch 358 comprises a strong, durable material, such as metal, steel, heavy gauge pipe, flat steel, wood, plastic, fiberglass, composite material or the like. The triple bale rear gate top bar 361 comprises a strong, durable material, such as metal, steel, heavy gauge pipe, flat steel, wood, plastic, fiberglass, composite material or the like. The triple bale rear gate bottom bar 362 comprises a strong, durable material, such as metal, steel, heavy gauge pipe, flat steel, wood, plastic, fiberglass, composite material or the like. The triple bale rear gate outer latch bar 363 comprises a strong, durable material, such as metal, steel, heavy gauge pipe, flat steel, wood, plastic, fiberglass, composite material or the like. The triple bale rear gate outer hinge bar 367 comprises a strong, durable material, such as metal, steel, heavy gauge pipe, flat steel, wood, plastic, fiberglass, composite material or the like. The triple bale rear gate vertical inner support bars 364 comprise a strong, durable material, such as metal, steel, heavy gauge pipe, flat steel, wood, plastic, fiberglass, composite material or the like. The triple bale rear gate horizontal cross bar 365 comprises a strong, durable material, such as metal, steel, heavy gauge pipe, flat steel, wood, plastic, fiberglass, composite material or the like. The triple bale rear gate vertical cross bar 366 comprises a strong, durable material, such as metal, steel, heavy gauge pipe, flat steel, wood, plastic, fiberglass, composite material or the like. The triple bale rear gate hinges 369 comprise a strong, durable material, such as metal, steel, heavy gauge pipe, flat steel, wood, plastic, fiberglass, composite material or the like. The triple bale rear gate latch 368 comprises a strong, durable material, such as metal, steel, heavy gauge pipe, flat steel, wood, plastic, fiberglass, composite material or the like. The triple bale widthwise base bars 322 comprise a strong, durable material, such as metal, steel, heavy gauge pipe, flat steel, wood, plastic, fiberglass, composite material or the like. The triple bale skids 325 comprise a strong, durable material, such as metal, steel, heavy gauge pipe, flat steel, wood, plastic, fiberglass, composite material or the like. The triple bale lengthwise base bars 324 comprise a strong, durable material, such as metal, steel, heavy gauge pipe, flat steel, wood, plastic, fiberglass, composite material or the like. The triple bale center base bar 326 comprises a strong, durable material, such as metal, steel, heavy gauge pipe, flat steel, wood, plastic, fiberglass, composite material or the like. The triple bale outer support columns 332 comprise a strong, durable material, such as metal, steel, heavy gauge pipe, flat steel, wood, plastic, fiberglass, composite material or the like. The triple bale center support column 334 comprises a strong, durable material, such as metal, steel, heavy gauge pipe, flat steel, wood, plastic, fiberglass, composite material or the like. The triple bale center beam 346 comprises a strong, durable material, such as metal, steel, heavy gauge pipe, flat steel, wood, plastic, fiberglass, composite material or the like. The triple bale side beams 344 comprise a strong, durable material, such as metal, steel, heavy gauge pipe, flat steel, wood, plastic, fiberglass, composite material or the like. The triple bale cradle ribs 342 comprise a strong, durable material, such as metal, steel, heavy gauge pipe, flat steel, wood, plastic, fiberglass, composite material or the like. The materials listed herein are examples only and not intended to limit the scope of the present invention.

The advantages of the present invention include, without limitation, that it enables small farmers or ranchers to easily use round hay bales to feed livestock; that it supports one or more round hay bales above the ground to prevent rot and pest infestation and limits wasting hay, thereby saving expenses involved in feeding livestock; that it is easily loaded with one or more round hay bales; that is conveniently able to be relocated due to its skids; and that it provides a protected space under the round hay bales, which allows small animals and/or young livestock to feed from the underside of the round hay bales while being safely shielded from larger, more mature livestock simultaneous feeding from the round hay bales.

In broad embodiment, the present invention relates generally to an apparatus for feeding livestock, which suspends one or more round hay bales above the ground, preventing hay rot, at a height that enables animals to feed on the round hay bale from top to bottom and allows small or young animals to feed from the underside of the bale where they are better protected from the larger animals. In sum, the Round Bale Saddle Feeder invention provides a convenient and cost effective means of simultaneously feeding both large and small livestock with round hay bales.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

1. An apparatus for feeding large livestock and small livestock simultaneously, said large livestock comprising cattle, horses, pigs, or goats, and said small livestock comprising young cattle, young horses, young pigs, or young goats, said apparatus comprising:
an outer box frame, said outer frame box comprising
corner posts, said corner posts being vertical, and
open sides;
a saddle-shaped basket for supporting one or more round hay bales above the ground, said saddle-shaped basket being disposed within said outer box frame, said saddle-shaped basket comprising
a plurality of flat bars with openings large enough for livestock to feed through without becoming caught while feeding;
a base, said base supporting said corner posts of said outer frame and comprising pipe skids;
a plurality of vertical supports that extend from said base to the lowest point of the underside of said saddle-shaped basket, which support said saddle-shaped basket at a height sufficient to allow said small livestock to independently feed from underneath said saddle-shaped basket; and
small animal feeding zones, which are adapted for receiving said small livestock, said small animal feeding zones comprising the space under said saddle-shaped basket, between said open side of said outer box frame and said plurality of vertical supports, and above said base, said small animal feeding zones being free of obstacles other than said outer box frame, said corner posts, said base and said vertical supports;
whereby said small livestock may independently enter into said small animal feeding zones through said open sides of said outer frame box and independently feed from underneath said saddle-shaped basket in a protected manner while said large livestock may simultaneously feed from the sides of said saddle-shaped basket.

2. An apparatus of claim 1, further comprising one or more hinged gates with lockable latches on the end of said saddle-shaped basket, which provide access to said saddle-shaped basket without substantially obstructing said small animal feeding zones.

3. An apparatus for feeding two round hay bales to livestock, said apparatus comprising:
two apparatuses of claim 1, connected by a plurality of reinforcing bars that span the width of said apparatuses without substantially obstructing said small animal feeding zones; and
two hinged gates with lockable latches, each of said gates located on opposite exposed ends of said apparatus, which provide access to round hay bales loaded within said apparatus without substantially obstructing said small animal feeding zones.
